(19) United States
(12) Patent Application Publication
(10) Pub. No.: US 2004/0226326 A1
(43) Pub. Date: Nov. 18, 2004

(54) Handle with angled actuator

(76) Inventors: Dane Steffen, Sioux Falls, SD (US); John M. Clancy, Clawson, MI (US); Andre J. Denys, Sterling Heights, MI (US); Dan Raap, Hartford, SD (US)

Correspondence Address: TESTA, HURWITZ & THIBEAULT, LLP, HIGH STREET TOWER, 125 HIGH STREET, BOSTON, MA, 02110, US

(21) Appl. No.: 10/440,467

(22) Filed: May 16, 2003

(51) Int. Cl. E05B 13/10

(52) U.S. Cl. 70/208

(57) ABSTRACT

The invention relates to a pull for a door or window, the pull having a base defining a mounting plane. Mounted to the base is an actuator, for example a key-lock cylinder assembly, the actuator having an axis of rotation disposed at an acute angle relative to the mounting plane. Disposing the axis of rotation of the actuator at an acute angle relative to the mounting plane provides additional space for a user to comfortably access the actuator without scraping their hands against a door jamb.

### TECHNICAL FIELD

The invention relates to handles for doors and windows that are ergonomically designed to enhance ease of use.

### BACKGROUND OF THE INVENTION

Patio doors generally include a windowpane and a sash that surrounds and encloses the windowpane, the sash being capable of sliding with minimal resistance on a horizontal track. Mounted on the sash of the patio door is a pull or handle that is used to actuate the door along the track.

A current trend in the manufacturing of patio doors is to maximize the area of window panes to both enhance viewing enjoyment and to decrease the bulky appearance of the doors. As a consequence of window panes increasing in area, the sash that surrounds the window is decreasing in size. Accordingly, there is a reduced area of the sash on which to attach accessories, such as handles or pulls.

On patio doors incorporating large windows, the pull of the door is sometimes disposed on the sash in such close proximity to the door jamb that it becomes inconvenient and difficult for a user to apply force to the pull to open the door. Moreover, if a key-lock cylinder or other actuator is disposed in the pull, because of the small clearance between a user's hand and the door jamb, a user may scrape their hand against the door jamb while using the actuator.

It is, therefore, an object of the invention to provide a pull that overcomes the difficulties associated with the prior art.

### SUMMARY OF THE INVENTION

The invention relates to patio door handles or pulls that have a base and an actuator mounted to the base, for example, a key-lock cylinder assembly or a lever. The base includes a mounting plane which lies substantially flush against a sash of a door when the pull is secured to the door. The actuator has an axis of rotation disposed at an acute angle relative to the mounting plane. Disposing the axis of rotation of the actuator at an acute angle relative to the mounting plane increases the clearance between a user's hand and the door jamb when utilizing the actuator and when sliding the door, thereby reducing the potential of a user scraping their hand against the doorjamb. It is contemplated that a pull of the present invention could also be provided without an actuator.

One aspect of the invention relates to a pull for a sash. The pull includes a base defining a mounting plane and an actuator mounted to the base, the actuator having an axis of rotation disposed at an acute angle relative to the mounting plane. The acute angle may be between about 55 degrees and about 85 degrees. In another embodiment, the acute angle may be between about 65 degrees and about 75 degrees.

This aspect of the invention can also include any of the following features. The pull may include at least one gripping portion. The base may be made from any suitable material such as metal, polymer, wood, or combinations thereof. Also, mounting structure may be included for attaching the pull to the sash. In another embodiment, the actuator is a key-lock cylinder assembly. In yet another embodiment, the axis of rotation is angled away from a proximate edge of the sash when the pull is mounted thereto.

In another aspect of the invention, a pull for a sash is disclosed. The pull includes a base defining a mounting plane and a front plane, where the front plane is disposed at an acute angle relative to the mounting plane. The pull also includes an actuator mounted to the base, the actuator having an axis of rotation disposed substantially perpendicular to the front plane.

The pull may have the front plane disposed at an angle between about 5 degrees and about 35 degrees relative to the mounting plane. In another embodiment, the front plane may be disposed at an angle between about 15 degrees and about 25 degrees relative to the mounting plane. The base may be made from any suitable material such as metal, polymer, wood, or combinations thereof. In one embodiment, the pull may also have at least one gripping portion. In yet another embodiment, the pull may include mounting structure for attaching the pull to the sash. In yet another embodiment, the actuator is a key-lock cylinder assembly.

In another aspect, the invention discloses a pull for a sash. The pull includes a base defining a mounting plane and an aperture for receiving an actuator therein, the actuator having an axis of rotation, such that the axis is disposed at an acute angle to the mounting plane when the actuator is received in the aperture. In one embodiment, the acute angle may be between about 55 degrees and about 85 degrees relative to the mounting plane. In another embodiment, the acute angle may be between about 65 degrees and about 75 degrees relative to the mounting plane.

The pull can also have any of the following features. For example, the pull can include at least one gripping portion and can also include mounting structure for attaching the pull to the sash. In another embodiment, the base of the pull may be made from any suitable material such as metal, polymer, wood, or combinations thereof.

In another aspect of the invention, a key-lock cylinder assembly is disclosed. The key-lock cylinder assembly includes a shell, a core rotatably disposed within the shell about an axis of rotation, and a tail coupled to the core such that the tail is pivotable relative to the axis of rotation at an acute angle. The acute angle may be between about 5 degrees and about 35 degrees. In another embodiment, the acute angle may be between about 15 degrees and about 25 degrees.

The key-lock cylinder assembly may also further include a proximal neck and a distal body, where the neck is narrower than the body. In another embodiment, the key-lock cylinder includes an end cap for retaining the tail. In yet another embodiment, at least one of a mating surface of the core and the tail are chamfered.

These and other objects, along with advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis generally being placed upon illustrating the principles of the invention. In the following description, various embodiments of the present invention are described with reference to the following drawings, in which:

FIG. 1 is a front view of a prior art pull with a key-lock cylinder disposed on a front surface of the pull;

FIG. 2 is a front view of a pull in accordance with the invention with a key-lock cylinder assembly disposed on a front surface lying substantially on a front plane of the pull;

FIG. 3 is a schematic front view of one embodiment of a pull in accordance with the invention;

FIG. 4 is a schematic side view of the pull of FIG. 3;

FIG. 5 is a schematic end view of the pull of FIG. 3;

FIG. 6A is a schematic back view of the pull of FIG. 3;

FIG. 6B is a schematic cross-sectional view of the of the pull of FIG. 3 taken along line 6B-6B of FIG. 6A;

FIG. 7 is a schematic cross-sectional view of the pull of FIG. 3 taken along line 7-7 of FIG. 6A further including a key-lock cylinder assembly mounted therein;

FIG. 8 is a schematic front view of a key-lock cylinder assembly that can be used in accordance with the invention;

FIG. 9A is a schematic side view of the key-lock cylinder assembly of FIG. 8;

FIG. 9B is a schematic side view of a core for use in the key-lock cylinder assembly of FIG. 9A.

FIG. 9C is a schematic front view of a tail for use in the key-lock cylinder assembly of FIG. 9A.

FIG. 9D is a schematic side view of the tail of FIG. 9C.

FIG. 9E is a schematic end view of the tail of FIG. 9C.

FIG. 10 is a schematic top view of a bracket that can be used with a pull in accordance with the invention;

FIG. 11 is a schematic side view of the bracket of FIG. 10;

FIG. 12 is a schematic top view of the bracket of FIG. 10;

FIG. 13 is a schematic front view of an alternative embodiment of a pull in accordance with the invention; and

FIG. 14 is a schematic end view of the pull of FIG. 13.

### DETAILED DESCRIPTION OF THE DRAWINGS

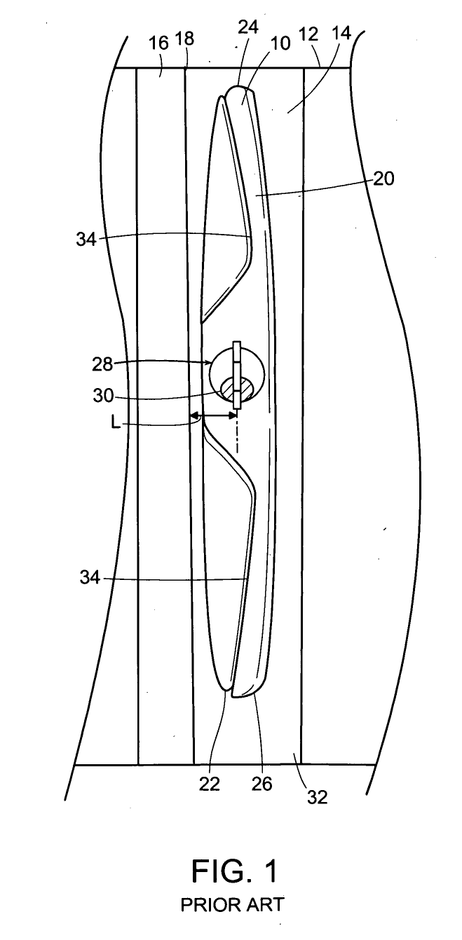

FIG. 1 depicts a prior art pull 10 shown mounted to the left hand side of a door 12 on the door's sash 14. Also depicted is a doorjamb 16, which abuts the left edge 18 of the door 12. The pull 10 includes a front surface 20 and further includes a ridge 22 disposed on the front surface 20 that extends from the top 24 of the pull 10 to the bottom 26 of the pull 10. A key-lock cylinder assembly 28 is mounted in the pull 10, such that the axis of rotation of the key-lock cylinder assembly 28 is perpendicular to a mounting plane 32 of the pull 10 that lies flush with the door 12. Two gripping areas 34 on the ridge 22 function as a grip for a user to actuate the door 12 along a horizontal track. As illustrated in FIG. 1, the distance (L) between the doorjamb 16 and the center of a key receiving portion 30 is sufficiently small that a user can scrape their hand(s) against the door jamb 16 when they attempt to use the key-lock cylinder assembly 28 to actuate the locking latch of door 12.

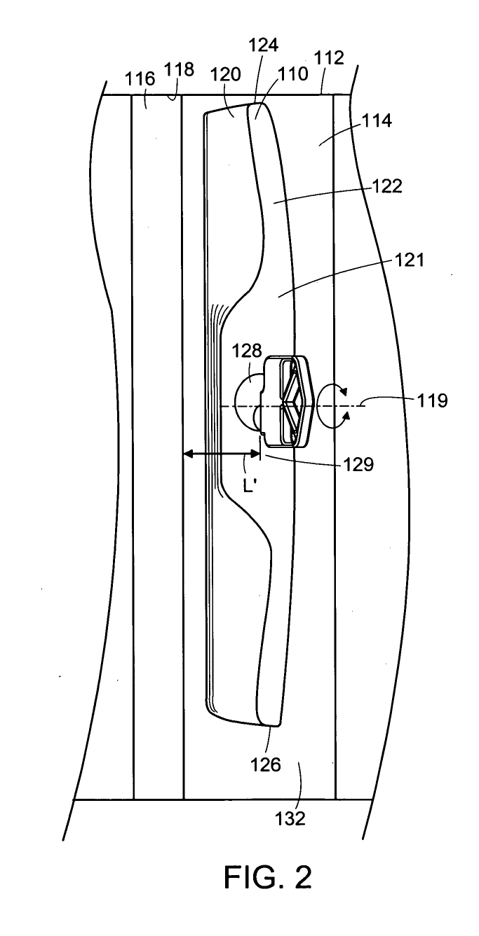

Referring to FIG. 2, a pull 110 in accordance with the invention is illustrated mounted to a sash 114 on the left side of a door 112. The door 112 shown is opened from the left; however, the pull 110 could be disposed on a door 112 that opens from either the left or right side, or any other orientation. Also depicted is a door jamb 116 that abuts the left edge 118 of the door 112. The pull 110 has a front surface 120 and further includes a ridge 122 disposed on the front surface 120 that generally extends from a top end 124 of the pull 110 to a bottom end 126 of the pull 110. An actuator 128, for example a key-lock cylinder assembly, is mounted in the pull 110, such that an axis of rotation 119 of the actuator 128 is substantially perpendicular to a surface 129 that lies on a front plane 121 of the pull 110. The front plane 121 is in turn disposed at an acute angle with respect to a mounting plane 132 of the pull 110, the mounting plane being flush with the door 112. Mounting the actuator 128 to the pull such that the axis of rotation 119 of the actuator 128 is at an acute angle relative to the mounting plane 132 increases the distance (L′) between the doorjamb 116 and the axis of rotation 119, relative to the prior art pull shown in FIG. 1 (i.e., L′>L). As a result of the larger distance (L′) between the door jamb 116 and the axis of rotation 119 of the actuator 128, improved access to the actuator 128 is enabled, and the user is less likely to scrape their hand(s) against the door jamb 116, as they utilize the actuator 128.

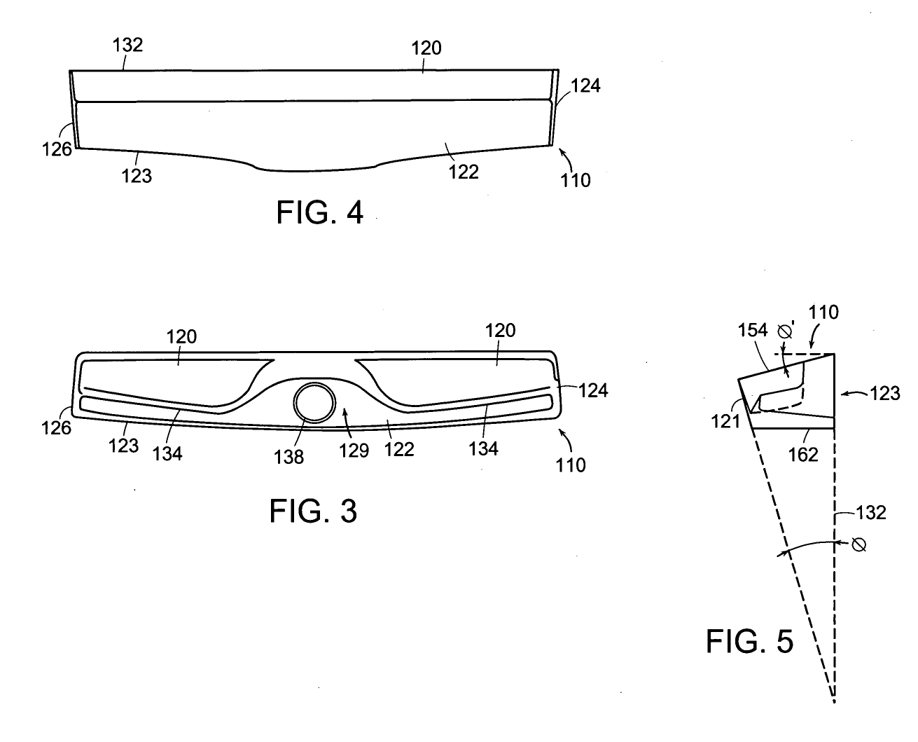

Referring to FIGS. 3-5, the pull 110 of FIG. 2 is shown in greater detail, but without the actuator 128. The pull 110 can be made from materials such as metals, woods, polymers, or combinations thereof. The pull 110 may be made from a zinc alloy, such as Zamac No. 3. Zamac is an alloy consisting primarily of zinc, aluminum, manganese, and copper. Zamac No. 3 is a suitable material for the pull 110, since it is resistant to corrosion and can be die cast, die casting being one method of manufacturing the pull 110.

Referring to FIGS. 3 and 4, the pull includes a base 123, the base 123 including the top end 124 and the bottom end 126, with the top end 124 and the bottom end 126 defining a longitudinal length therebetween. Extending in the longitudinal direction on the front surface 120 from the top end 124 of the pull 110 to the bottom end 126 is the ridge 122 that protrudes outwardly from the mounting plane 132 of the pull 110. At approximately the center of the ridge 122, there is a knockout 138 that can be forced out to provide an opening to receive the actuator 120, as shown in FIG. 2. The ridge 122 also includes a pair of gripping portions 134 that are approximately perpendicular to the mounting plane 132. The gripping portions 134 can be used to slide the door 112 along the horizontal track. It will be appreciated that the gripping portions 134 can be altered to include moldings to receive a user's fingers. The gripping portions 134 can also be angled with respect to the mounting plane 132 such that a greater distance is provided between the gripping portions 134 and the door jamb 116. In another embodiment, the gripping portion 134 can be a portion of the base 123 itself, such as a side wall of the base 123, or could be bonded to the base 123. It will be appreciated that for esthetic reasons, there are numerous ways to include gripping portions 134 on the pull 110, all of which are included in the scope of the invention.

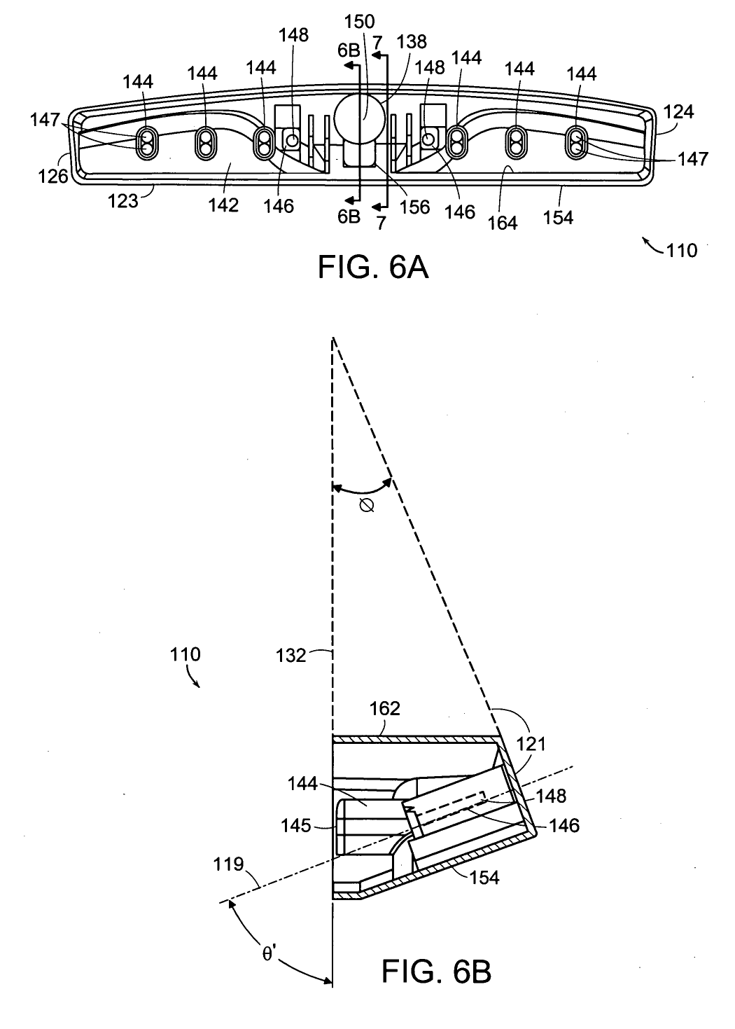

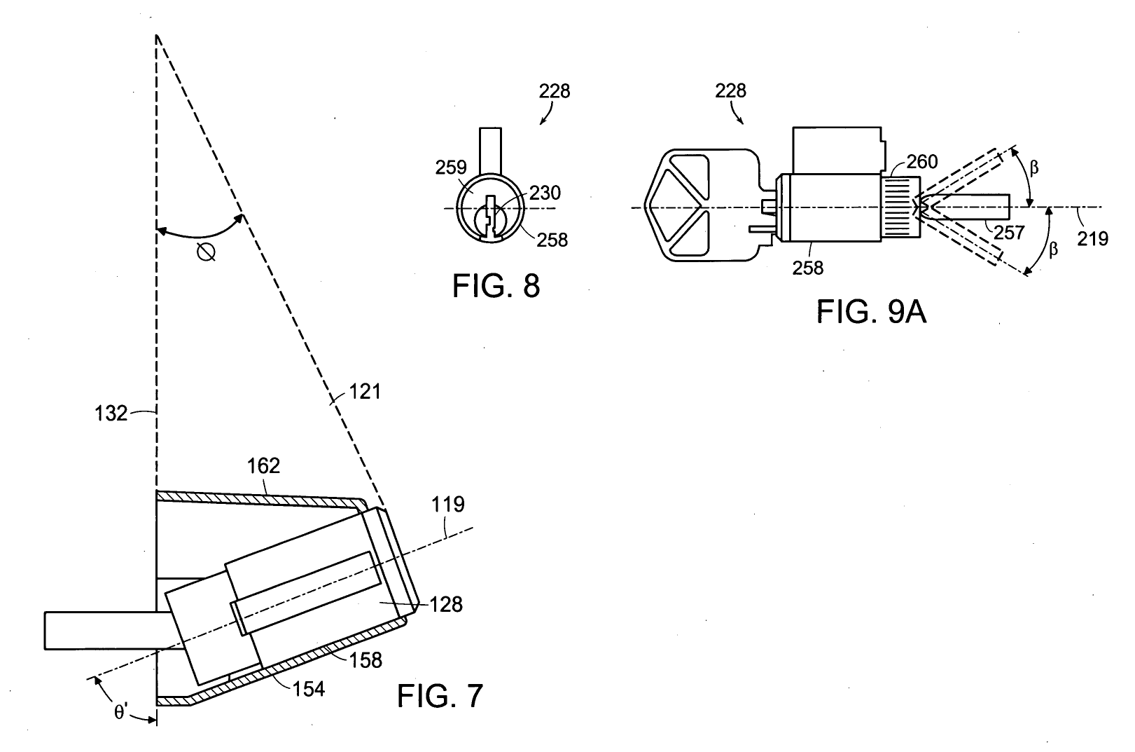

Referring to FIG. 5, an end view of the pull 110 is shown. Depicted in the end view are the front plane 121, the mounting plane 132, and proximal and distal side walls 162, 154 of the pull 110. Referring also to FIGS. 6B and 7, the front plane 121 of the pull 110 is angled with respect to the mounting plane 132 of the pull 110 at an angle (Ø). The angle (Ø) being less than 90 degrees, preferably the angle (Ø) is from about 5 degrees to about 35 degrees, and more preferably the angle (Ø) is from about 15 degrees to about 25 degrees relative to the mounting plane 132.

Referring to FIG. 6A, a back view of the pull 110 is shown. The pull 110, viewed from the back, is essentially hollow, like a shell, such that a back surface 142 of the pull 110 mirrors the contours of the front surface 120 shown in FIG. 3. Alternatively, the pull 110 can be a solid piece. The back surface 142 of the pull 10 may include mounting structure for mounting the pull 110 to the door 112. The back surface 142 of the pull 110 shown in FIG. 6A includes six stand-offs 144, each having two internal threads 147. The ends 145 of the six stand-offs 144 are counter sunk in relation to the mounting plane 132 that in turn lies flush against the surface of the door 112. The two internal threads 147 and the six stand-offs 144 provide flexibility to mount the pull 110 to doors 112 produced by different manufacturers. It is appreciated that the number of stand-offs 144, threads 147, or other mounting structure, as well as their placement, can be varied as needed to accommodate different doors without exceeding the scope of the invention.

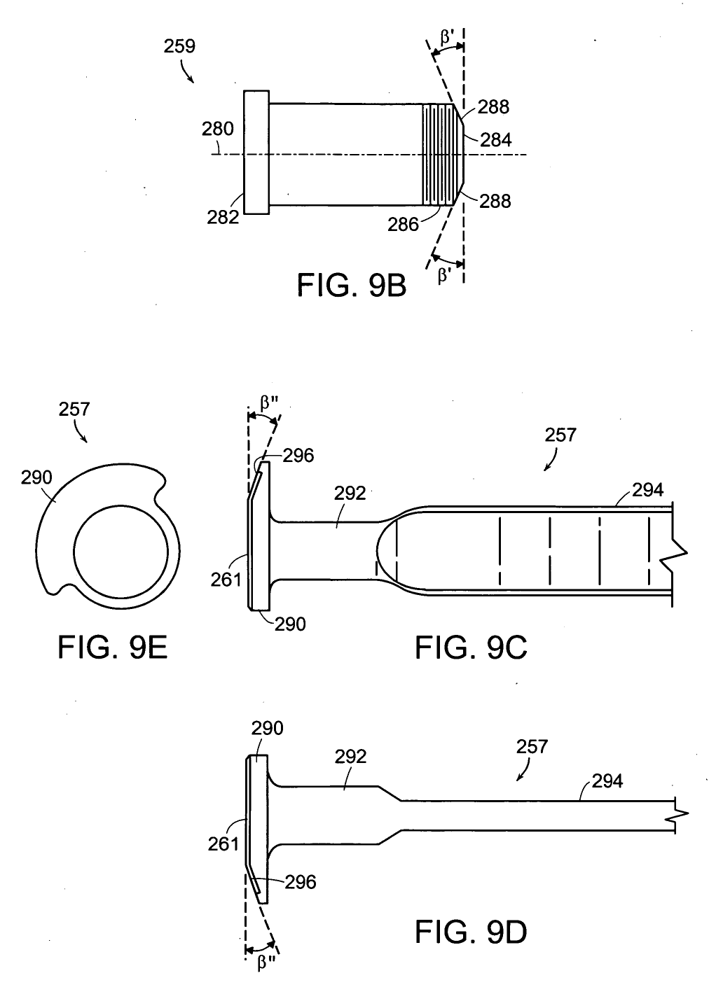

Referring again to FIGS. 6A and 6B, also included on the back surface 142 is a second mounting structure 146 consisting of two threaded holes 148 spaced longitudinally apart. The holes 148 are threaded at an angle approximately 90 degrees relative to the front plane 121 of the pull 110. Disposed between the threaded holes 148 of the second mounting structure 146 is an aperture 150 that can receive the actuator 128, for example, a key-lock cylinder assembly 228 (FIGS. 8 and 9A). As shown in FIGS. 8 and 9A, the key-lock cylinder assembly 228 has a generally cylindrical shell 258 and a core 259 that defines a key receiving portion 230. The distal side wall 154 of the aperture 150 has a semi-circular internal surface 156 that mates with the cylindrical shell 258 of the key-lock cylinder assembly 228, such that when the key-lock cylinder assembly 228 is placed in the aperture 150, longitudinal movement of the key-lock cylinder assembly 228 is at least partially restricted.

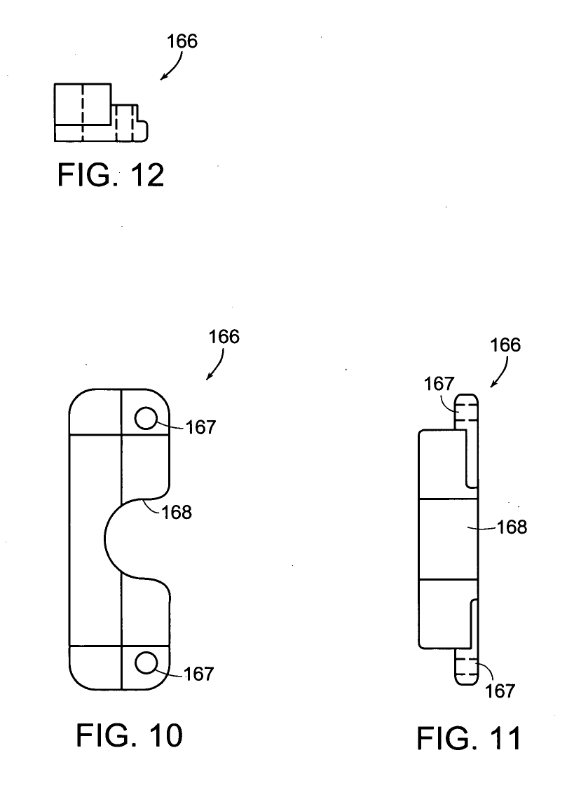

If the pull 110 is manufactured to include the actuator 128, the actuator 128 is placed into the aperture 150 through the back of the pull 110 and held in place within the pull 110 by mounting means. The mounting means includes the semi-circular surface 156 that protrudes from the back side 164 of the distal side wall 154. Also included in the mounting means is a bracket 166 (FIGS. 10-12). The bracket 100 can be made from a metal, a wood, or a polymer, such as nylon.

Referring to FIGS. 10-12, the bracket 166 includes a semi-circular cut-out 168 that receives, for example, the cylindrical shell 258 of the key-lock cylinder assembly 228. Also included in the bracket 166 are a pair of through holes 167 that can receive fasteners to secure the bracket 166 to the threaded holes 148 of the second mounting structure 146. To secure the key-lock cylinder assembly 228 in the pull 110, the key-lock cylinder assembly 228 is placed in the pull 110, and the bracket 166 is secured to the second mounting structure 146. The semi-circular cut-out 168 of the bracket 166, together with the semi-circular surface 156 of the distal side wall 154 act together to minimize movement of the key-lock cylinder assembly 228 in the pull 110.

Referring again to FIGS. 6B and 7, it will be appreciated that since the second mounting structure 146 and the distal side wall 154 are each angled substantially the same amount (Ø′) with respect to the mounting plane 132, the actuator 128 will also be secured in the pull 110 at substantially the same angle (Ø′) relative to the mounting plane 132. Moreover, the angle of the axis of rotation 119 of the actuator 128 relative to the mounting plane 132 will be (Ø′), the angle (Ø′) being less than 90 degrees. Preferably the angle (Ø′) is between about 55 degrees and about 85 degrees. More preferably, the angle (Ø′) is between about 65 degrees and about 75 degrees.

In another embodiment, the pull 110 of the present invention can be manufactured to exclude the actuator 128 (see, for example, FIG. 3). If the pull 110 is made to exclude the actuator 128, the knockout 138 (FIG. 3) on the ridge 122 may not be included in the pull 110 for esthetic purposes; however, the front plane 121 of the pull 110 will remain angled with respect to the mounting plane 132 of the pull 110, as described above. Also, in this embodiment, it is possible to add the actuator 128 to the pull 110 at a later time, if desired.

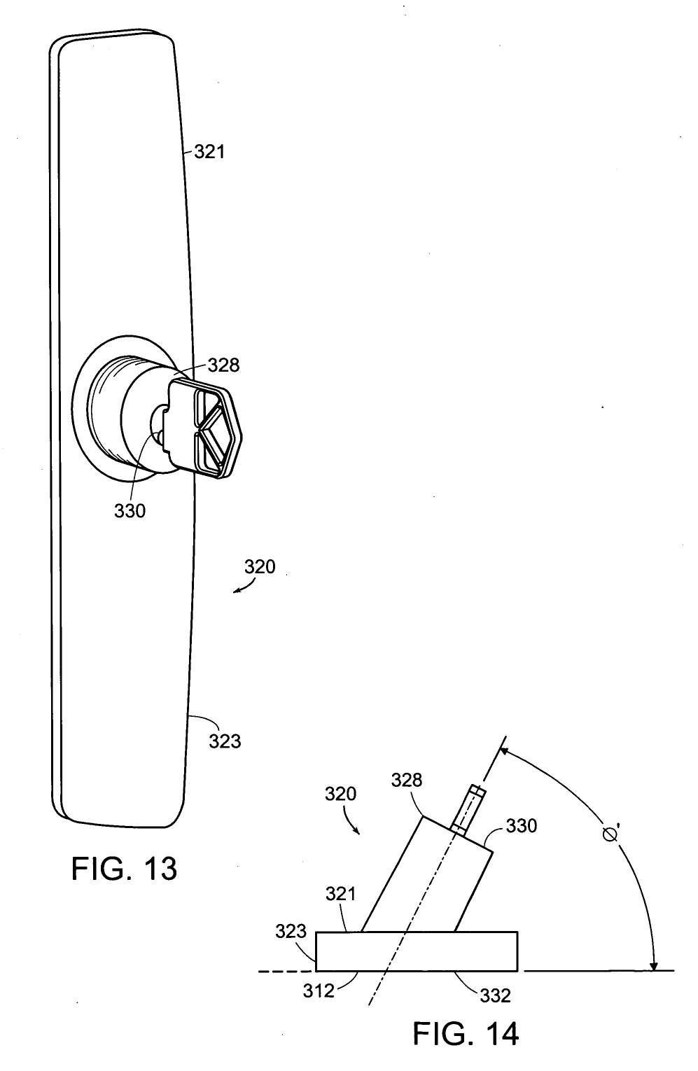

In yet another embodiment, as shown in FIGS. 13 and 14, a pull 320 includes a base 323 having a front surface 321 and a back surface 317, with the front surface 321 and the back surface 317 being substantially parallel and the back surface 217 defining a mounting plane 232. An actuator, such as a key-lock cylinder assembly 328, is secured to the base 323 at an angle (Ø′) relative to the mounting plane 332. The angle (Ø′) being less than 90 degrees, preferably the angle (Ø′) is from about 55 degrees to about 85 degrees, and more preferably the angle (Ø′) is from about 65 degrees to about 75 degrees relative to the mounting plane 332. Similar to the embodiments described above, the pull 320 can further include a gripping portion and mounting structure for attaching the pull 320 to a sash. Also, the pull 320 can be made from materials including metals, polymers, woods, or combinations thereof.

Referring to FIGS. 8-9D, the key-lock cylinder assembly 228 includes the core 259, the cylindrical shell 258, a tail 257, and an end cap 260. As best shown in FIGS. 8 and 9A, the core 259 is rotatably disposed within the cylindrical shell 258 about an axis of rotation 219. The tail 257 is coupled to the core 259 such that the tail 257 is pivotable relative to the axis of rotation 219 at an angle (β) less than 90 degrees. Preferably, the angle (β) is from about 0 degrees to about 25 degrees. More preferably, the angle (β) is from about 0 degrees to about 35 degrees.

Referring to FIG. 9B, the core 259 of the key-lock cylinder assembly 228 is shown in greater detail. The core 259 includes a proximal end 282 and a distal end, or mating surface 284 defining a length therebetween. Located near the mating surface 284 are threads 286 that receive the end cap 260. The mating surface 284 of the core 259 also has an optional chamfered edge 288. The angle (β′) of the chamfered edge 288 is approximately equal to the angle (β) the tail 257 may pivot relative to the axis of rotation 219 of the core 259 of the key-lock cylinder assembly 228. When the tail 257 is coupled to the core 259 as shown in FIG. 9A, a head 190 of the tail 257 (FIG. 9C) rests on the chamfered edge 288, thereby pivoting the tail 257 with respect to the axis of rotation 219.

Referring to FIGS. 9C-9E, the tail 257 includes the head 290, a proximal neck 292 and a distal body 294, where the neck 292 is located proximal to the head 290 and the body 294 is located distally from the head 290. The neck 292 is generally cylindrical in shape and tapers up to the body 294, which is generally rectangular in shape. A mating surface 261 of the head 290 may include an optional chamfered edge 296. Preferably, the angle (β″) of the chamfered edge 296 is from about 0 degrees to about 25 degrees. More preferably, the angle (β″) of the chamfered edge 196 is from about 0 degrees to about 35 degrees. When the tail 257 of the key lock cylinder assembly 228 is pivoted with respect to the axis of rotation 219, the chamfered edge 296 of the tail 257 may rest on the chamfered edge 288 of the core 259, thereby enabling a maximum amount of pivoting of the tail 257 relative to the axis of rotation 219. In another embodiment, only one of the mating surfaces 261, 284 of the core 259 and the tail 257 may have a chamfered edge to enable the tail 257 to pivot about the axis of rotation 219.

The ability to pivot the tail 257 of the key-lock cylinder assembly 228 relative to the axis of rotation 219 is desirable when an actuator, such as the key-lock cylinder assembly 228, has an axis of rotation that is disposed at an acute angle relative to a mounting plane. Generally, the body 294 of the tail 257 couples to a pivot axis of a latch at its distal end, the pivot axis being substantially perpendicular to the surface of a door. Such a latch is described in U.S. Pat. No. 5,820,170 to Clancy, which is hereby incorporated herein by reference in its entirety. For this reason, i.e. to actuate the latch, it is desirable to enable the tail 257 to pivot relative to the axis of rotation 119, 219 of the actuator 128, 228.

Other embodiments incorporating the concepts disclosed herein may be used without departing from the spirit and scope of the invention. The described embodiments are to be considered in all respects as only illustrative and not restrictive.

What is claimed is:

1. A pull for a sash, comprising:
a base defining a mounting plane; and
an actuator mounted to the base, the actuator having an axis of rotation disposed at an acute angle relative to the mounting plane.

2. The pull of claim 1 further comprising at least one gripping portion.

3. The pull of claim 1, wherein the acute angle is between about 55 degrees and about 85 degrees.

4. The pull of claim 1, wherein the acute angle is between about 65 degrees and about 75 degrees.

5. The pull of claim 1, wherein the base is made from a material selected from the group consisting of metal, polymer, wood, and combinations thereof.

6. The pull of claim 1 further comprising mounting structure for attaching the pull to the sash.

7. The pull of claim 1, wherein the actuator comprises a key-lock cylinder assembly.

8. The pull of claim 1, wherein the axis of rotation is angled away from a proximate edge of the sash when the pull is mounted thereto.

9. A pull for a sash, comprising:
a base defining a mounting plane and a front plane, the front plane disposed at an acute angle relative to the mounting plane; and
an actuator mounted to the base, the actuator having an axis of rotation disposed substantially perpendicular to the front plane.

10. The pull of claim 9, wherein the front plane is disposed at an angle between about 5 degrees and about 35 degrees relative to the mounting plane.

11. The pull of claim 9, wherein the front plane is disposed at an angle between about 15 degrees and about 25 degrees relative to the mounting plane.

12. The pull of claim 9 further comprising at least one gripping portion.

13. The pull of claim 9, wherein the base is made from a material selected from the group consisting of metal, polymer, wood, and combinations thereof.

14. The pull of claim 9 further comprising mounting structure for attaching the pull to the sash.

15. The pull of claim 9, wherein the actuator comprises a key-lock cylinder assembly.

16. A pull for a sash, comprising:
a base defining a mounting plane and an aperture for receiving an actuator therein, the actuator having an axis of rotation, such that the axis is disposed at an acute angle to the mounting plane when the actuator is received in the aperture.

17. The pull of claim 16 further comprising at least one gripping portion.

18. The pull of claim 16, wherein the base is made from a material selected from the group consisting of metal, polymer, wood, and combinations thereof.

19. The pull of claim 16 further comprising mounting structure for attaching the pull to the sash.

20. The pull of claim 16, wherein the acute angle is between about 55 degrees and about 85 degrees relative to the mounting plane.

21. The pull of claim 16, wherein the acute angle is between about 65 degrees and about 75 degrees relative to the mounting plane.

22. A key-lock cylinder assembly comprising:
a shell;
a core rotatably disposed within the shell about an axis of rotation; and
a tail coupled to the core such that the tail is pivotable relative to the axis of rotation at an acute angle.

23. The key-lock cylinder assembly of claim 22, wherein the acute angle is between about 5 degrees and about 35 degrees.

24. The key-lock cylinder assembly of claim 23, wherein the acute angle is between about 15 degrees and about 25 degrees.

25. The key-lock cylinder assembly of claim 22, wherein at least one of a mating surface of the core and the tail are chamfered.

26. The key-lock cylinder assembly of claim 22, further comprising a proximal neck and a distal body, wherein the neck is narrower than the body.

27. The key-lock cylinder assembly of claim 22, further comprising an end cap for retaining the tail.
